(19) United States
(12) Patent Application Publication
(10) Pub. No.: US 2019/0081915 A1
(43) Pub. Date: Mar. 14, 2019

(54) EXTENSIONS EMBEDDED IN E-MAIL MESSAGES

(71) Applicant: Microsoft Technology Licensing, LLC, Redmond, WA (US)

(72) Inventors: Peter Loren Engrav, Seattle, WA (US); Julio Estrada, Bellevue, WA (US); Ned Bearer Friend, Seattle, WA (US); Nathaniel Marvin Myhre, Kirkland, WA (US); Vignesh Sachidanandam, Seattle, WA (US)

(21) Appl. No.: 15/699,495

(22) Filed: Sep. 8, 2017

(51) Int. Cl. H04L 12/58; H04L 29/08

(52) U.S. Cl. CPC H04L 51/046; H04L 51/08; H04L 51/22; H04L 67/20

(57) ABSTRACT

Systems, methods, and software are disclosed herein to launch embedded extensions in the context of an e-mail application. In an implementation, a user may interact with an e-mail application. An e-mail message is received into an inbox of the e-mail application. The e-mail message may include an embedded extension. The user opens the e-mail, including the embedded extension, for viewing. While viewing the e-mail message, the user clicks on the embedded extension, which launches the embedded extension within the context of the e-mail application.

### TECHNICAL BACKGROUND

E-mail applications provide users with effective and convenient ways to communicate with others and manage their information. Some e-mail applications integrate other functions such as calendar, contact list, and to-do lists, although each functionality may also be provided in a stand-alone manner Such applications are sometimes referred to as personal information management (PIM) applications, of which Microsoft Outlook® is one example.

Additional features or functionality may be added to an e-mail application using a plug-in or add-in. An add-in is a software component that adds one or more features to an existing program or application. Starbucks® for Outlook® is one example of such add-ins that allows users to purchase and send Starbucks® eGift cards using Outlook.

Add-ins are typically downloaded and installed from an add-ins store. The store may be accessed through a native application (e.g. Outlook) and an icon for the add-in may be rendered in the user interface to the native application. After an add-in has been downloaded and installed, a user can launch the add-in from within the native application's user interface. However, when the add-in runs, it actually runs within the context of a browser application or other supporting framework. Furthermore, add-ins cannot be included in email messages, nor can their installation be automatically triggered by opening an email message.

### OVERVIEW

Provided herein are systems, methods, and software for launching embedded extensions in the context of an e-mail application. In an implementation, a user may receive an e-mail including an embedded extension into an inbox of an e-mail application. When the user opens the email, the embedded extension may execute and be rendered in the viewing pane for the email.

In some implementations, the user may click-on or otherwise select the e-mail that includes the embedded extension, which opens the e-mail message for viewing. While viewing the e-mail message, the user may click-on or otherwise select the embedded extension. In response, the embedded extension is launched in the context of the e-mail application.

For example, the embedded extension may only run as long as the e-mail application remains open. When the user closes the e-mail application, the embedded extension will also close. In addition, the embedded extension may utilize native controls of the e-mail application. In some implementations, the embedded extension may be launched when the user open the e-mail including the embedded extension.

The foregoing Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIGS. 1A-1C illustrate an operational environment for launching extensions embedded in e-mail messages in the context of an e-mail application.

FIGS. 2A-2B illustrate another operational environment for launching extensions embedded in e-mail messages in the context of an e-mail application.

FIG. 3 illustrates a process implemented by the e-mail application to launch embedded extensions.

FIG. 4A-4B illustrates an operational scenario where the embedded extension interacts with a third-party service.

FIGS. 5A-5E illustrate various operational scenarios for launching extensions embedded in e-mail messages in the context of an e-mail application.

FIG. 6 illustrates an operational scenario for launching extensions natively within an e-mail application.

FIG. 7 illustrates various components of an email application in an implementation.

FIG. 8 illustrates a computing system suitable for implementing the email technology disclosed herein, including any of the applications, extensions, architectures, elements, processes, and operational scenarios and sequences illustrated in the Figures and discussed below in the Technical Disclosure.

### TECHNICAL DISCLOSURE

Implementations are disclosed herein for launching embedded extensions in the context of an e-mail application. In at least one implementation, a user may interact with an e-mail application. In some examples, the e-mail application may comprise a dedicated or stand-alone e-mail application, an email module within a personal information management application, or any other type of application capable of receiving e-mail messages.

An e-mail message is received into an inbox of the e-mail application. The e-mail message may include an embedded extension. In some examples, the e-mail message may also include other attachments in addition to the embedded extension. The e-mail message may also include multiple embedded extensions. Examples of embedded extensions include, but are not limited to, flight check-in extensions, chat extensions, or the like.

In operation, a user opens the e-mail, including the embedded extension, for viewing. The embedded extension may execute upon the email opened in some implementations. In other implementations, the user clicks on the embedded extension, which launches the embedded extension within the context of the e-mail application. When the user closes the e-mail application, the embedded extension may also be closed.

In a brief operational example, a user previously booked a flight to Seattle, Wash. Twenty-four hours before the scheduled time for the flight, the airline sends an e-mail message to the user that includes the flight details and a reminder to check-in. The e-mail message also includes an embedded extension that allows the user to check-in for the scheduled flight and choose a seat. The embedded extension may comprise a collection of code, programs, logic, scripts, modules, or other computer readable instructions. In some implementations, extensions may comprise applications.

The user opens the e-mail message from the airline for viewing. The e-mail message may include an indication that an extension is embedded, such as a symbol or other indicator. The user selects or opens the embedded extension, and the embedded extension launches in the context of the e-mail application. In some examples, the embedded extension may launch in a pane or another window of the e-mail application.

The user interacts with the embedded extension. In some examples, the embedded extension may extract information from the e-mail message. For instance, the embedded extension for checking-in for the scheduled flight may extract a confirmation number, passenger information, or other information to look up the flight and populate fields for the user.

In some instances, the embedded extension may launch a third-party service, such as a chat extension, application, or bot. For example, the flight check-in extension may launch a bot for hotel reservations in the destination city. In some implementations, the e-mail application may also launch or spawn an application for monitoring the third-party service.

The user may also wish to save the embedded extension to use again later, but delete the e-mail message that included the embedded extension. In some implementations, the user may save the embedded extension to the e-mail application; allowing the embedded extension to be accessible from the e-mail application even after the e-mail message containing the embedded extension has been deleted.

A technical effect provided by the technology disclosed herein is the ability to launch extensions embedded in e-mail messages in the context of an e-mail application. This avoids the necessity of a user having to navigate to a website or download a separate application in order to interact with an online service, e.g. a flight reservation system.

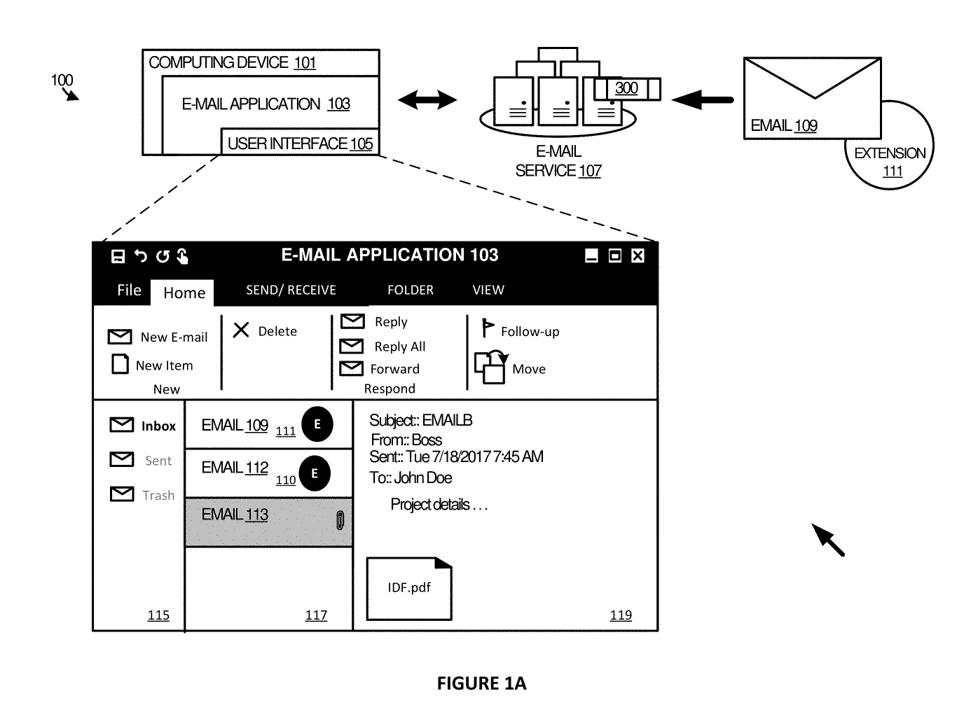

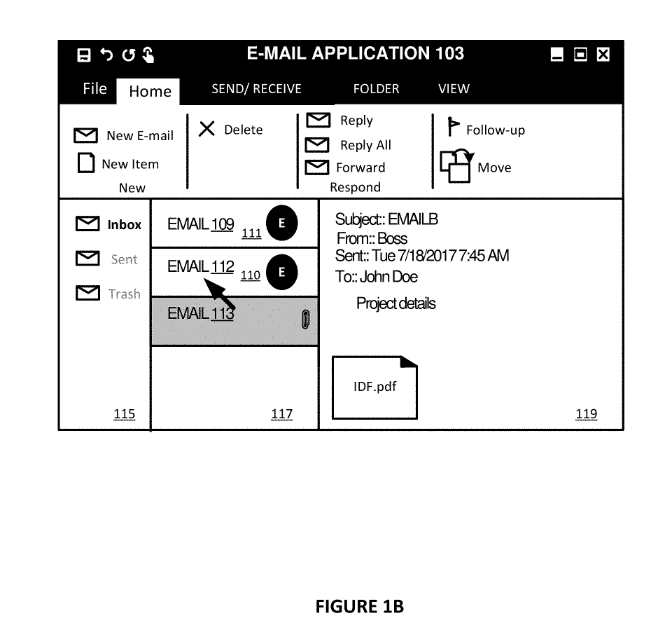

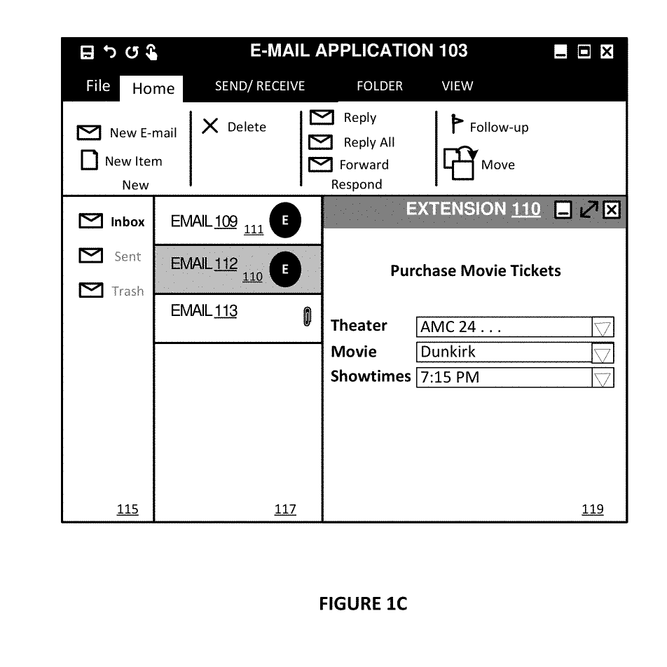

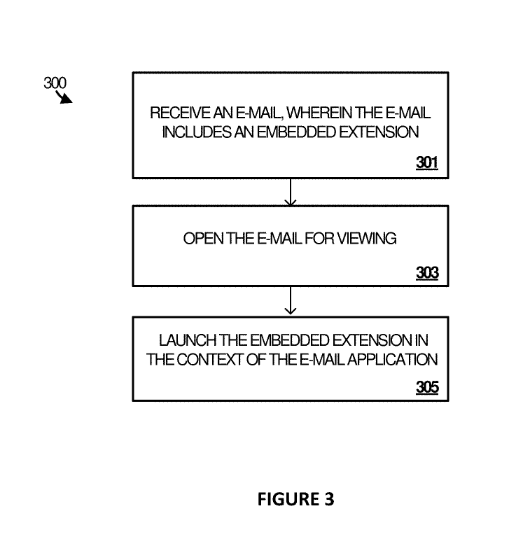

FIGS. 1A-1C illustrate operational environment 100 in an implementation of e-mail application 103 launching embedded extension 111 employing process 300, illustrated in FIG. 3. As illustrated, process 30 may also be employed by e-mail service 107. Process 300 may be implemented in one or more software components, modules, or other such logical constructs that execute in the context of the e-mail application.

Referring briefly to the steps illustrated in FIG. 3, an e-mail message, including an embedded extension, is received into the inbox of e-mail application 103 (step 301). The user may select or open the e-mail message containing the embedded extension (step 303). E-mail application 103 launches the embedded extension in the context of the e-mail application (step 305). In some implementations, the embedded extension is launched upon the user navigating to the e-mail message. In other implementations, the user opens the e-mail message including the embedded extension, the embedded extension launches when the user double-clicks or otherwise selects the embedded extension.

Referring back to FIGS. 1A-1C, the operational scenario illustrated therein is representative of one implementation of process 300 by e-mail application 103 to launch embedded extensions.

E-mail application 103 runs on computing device 101. For example, e-mail application 103 may be a dedicated e-mail extension or a personal information management program that includes an e-mail component or module. In one example, computing device 101 may include a client computing device. In a basic configuration, computing device 101 may be personal computer having user interface 105 comprising both input elements and output elements. Computing device 101 may be any suitable computing device for executing e-mail application 103. For example, computing device 101 may be at least one of: a personal computer; a desktop computer; a laptop computer; a gaming device/computer (e.g., Xbox®); a television; a smart phone; a tablet; a phablet; a smart watch; a wearable computer; etc. This list is exemplary only and should not be considered as limiting. Any suitable client computing device for executing e-mail application 103 may be utilized.

A user interacts with e-mail application 103 using user interface 105. For example, the user may draft or view e-mail messages, in local application 103 using user interface 105. In one example, user interface 105 comprises a means for input and output, such as a keyboard, mouse, and/or touch screen. E-mail service 107 may reside on a cloud service. E-mail messages 109, 112, and 113 may be received at e-mail service 107. E-mail messages 109 and 112 include embedded extensions 111 and 110, respectively. As illustrated, embedded extensions are denoted by the circle with the letter “E,” however, other indications may be used. E-mail messages 112 and 113 include attachments, as indicated with the paperclip icon. E-mail application 103 and e-mail service 107 may communicate over a network such as the Internet.

User interface 105 in FIG. 1A includes an open window for e-mail application 103. A user may select a folder from navigation pane 115, such as the inbox, sent folder, or trash. Message list 117 shows messages in the selected folder, in this case the inbox. In some implementations, message list 117 may include a preview or the first few lines of each e-mail message. The selected e-mail message is displayed on reading pane 119. In FIG. 1A, e-mail message 113 is selected in message list 117 and the user may view the e-mail message and access various attached files in reading pane 119. User interface 105 also includes a menu from which to select various feature menus, including a file, home, send/receive, folder, and view menus. In this scenario, the home menu has been selected.

In response to the user selecting e-mail 113 in message list 117, the content of e-mail message 113 is displayed in reading pane 119. E-mail message 113 includes an attachment, the user may open the attachment by double-clicking or otherwise selecting the attachment, labeled “IDF.pdf.”

FIG. 1B illustrates the user navigating to e-mail message 112. E-mail message 112 includes embedded extension 110 and an attachment. In FIG. 1C, the user has selected e-mail message 112. Embedded extension 110 is launched in reading pane 119 when the user opens e-mail message 112. Advantageously, embedded extension 110 launches when e-mail message 112 is opened, and no further action is required from the user to launch embedded extension 110. As illustrated, embedded extension 110 comprises an application for purchasing movie tickets.

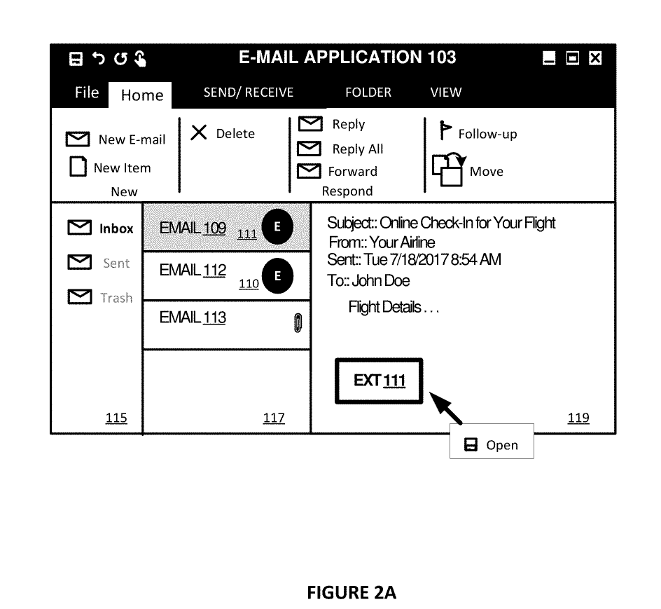

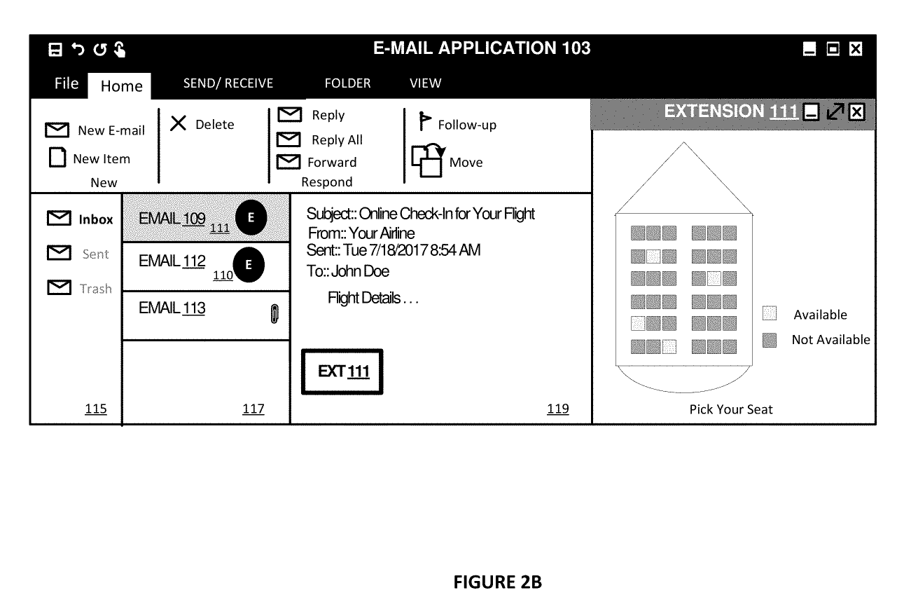

FIGS. 2A-2B illustrate another operational scenario to launch embedded extensions in the context of e-mail application 103.

As shown, the user has selected e-mail 109, which includes embedded extension 111. For example, e-mail message 109 may comprise a remainder e-mail from an airline to check-in for the user's upcoming flight. The user right-clicks extension 111, and is given the option to open, run, or otherwise launch embedded extension 111. FIG. 2B continues the illustration of the operational scenario, after embedded extension 111 has been launched in the context of e-mail application 103.

As shown, embedded extension 111 comprises a seat-picking extension for the user's upcoming flight. Embedded extension 111 may launch in another pane, as shown, or within reading pane 119. In implementations, embedded extension 111 may include other features, such as check-in capabilities, not shown in the Figure. In some implementations, extension 111 may automatically obtain data from e-mail message 109 to be used in extension 111. For example, embedded extension 111 may scan e-mail message 109 for a confirmation number to look-up the flight details without the user having the enter the confirmation number.

Embedded extension 111 allows the user to select a seat on the upcoming flight. Embedded extension may be closed once the user has completed the seat selection process. In some implementations, embedded extension 111 may be popped-out for the window, for better viewing.

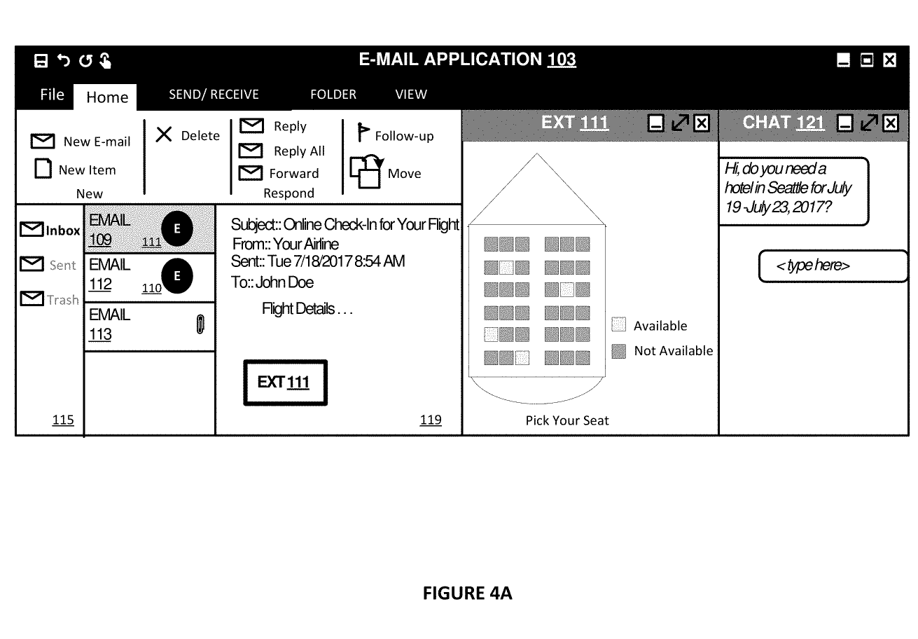

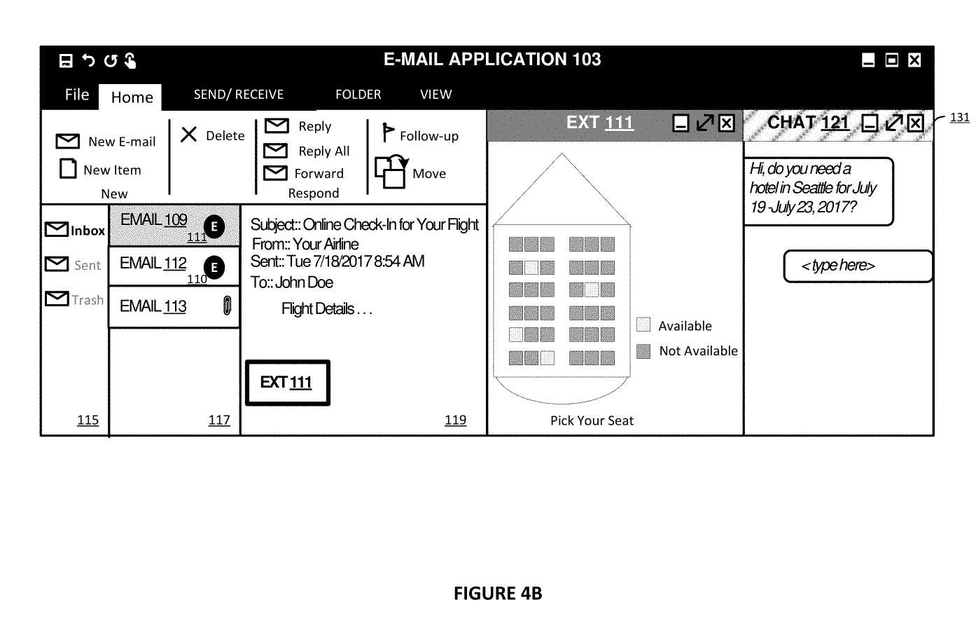

In another implementation, FIG. 4A illustrates a user interface to e-mail application 103, where embedded extension 111 interacts with chat 121, which may comprise a third-party service. For example, chat 121 may comprise a bot for making hotel reservations in your destination city. In other examples, chat 121 may comprise a reservation bot with the airline with which your flight is booked, to help with checking-in or other questions. In some implementations, chat 121 may also be popped out into a new window, similar to embedded extension 111. Chat 121 may or may not be embedded in e-mail 109. Although not required, the user may also be able to save chat 121 as an extension accessible in e-mail extension 103 for future use after the current chat session has been ended.

In one implementation, e-mail application 103 may spawn a guardian application 131, to monitor embedded extension 111 interactions with chat 121, as illustrated in FIG. 4B. The title bar for chat 121 with the diagonal stripes indicates guardian application 131 is running in the background, monitoring chat 121. The pattern or color of the title bar may change based on a determination by guardian application 131 of how trustworthy and/or secure the interaction is between embedded extension 111 and chat 121. In other implementations, guardian application 131 may make a security determination for chat 121 and indicate the determination to the user.

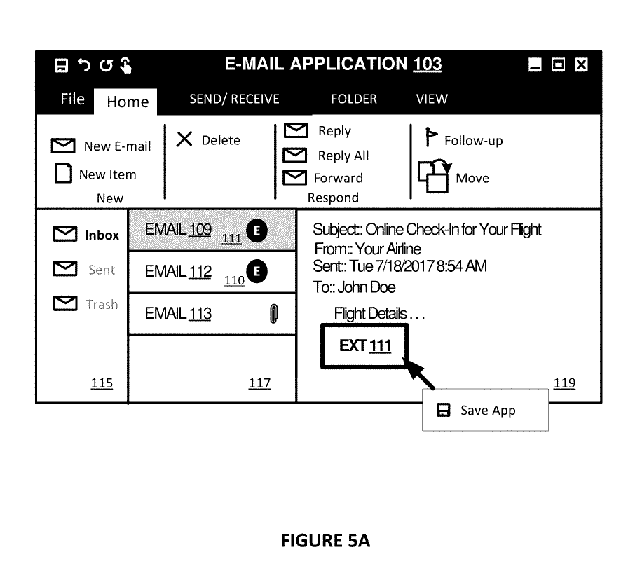

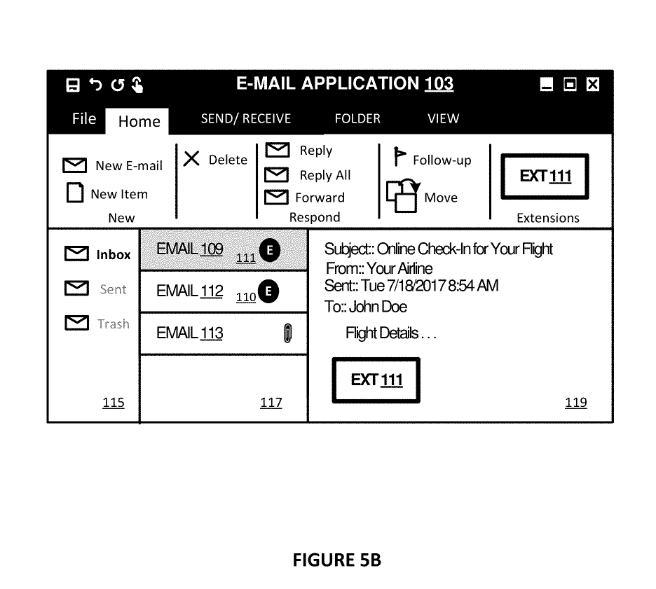

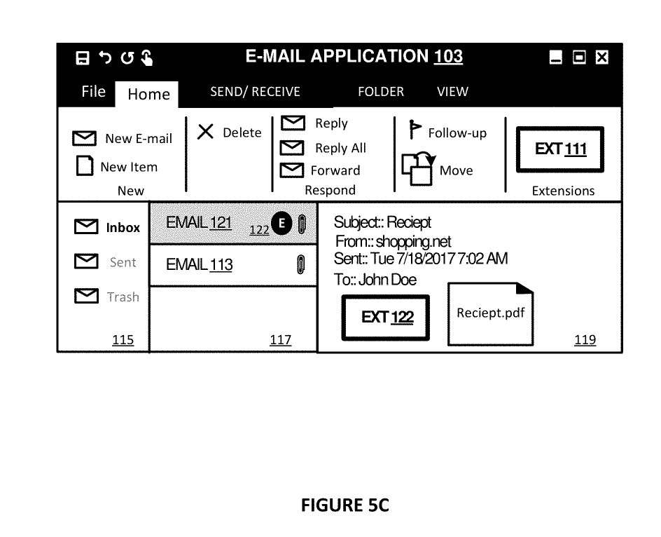

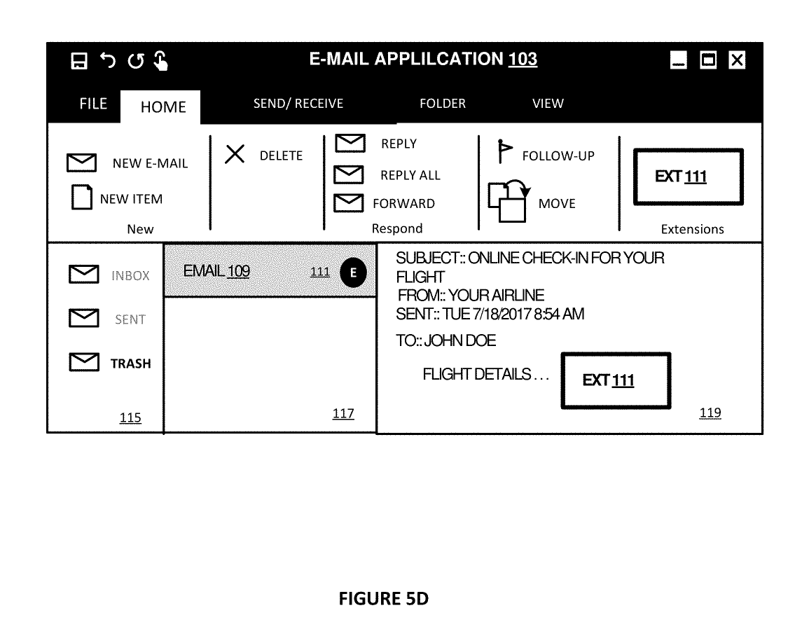

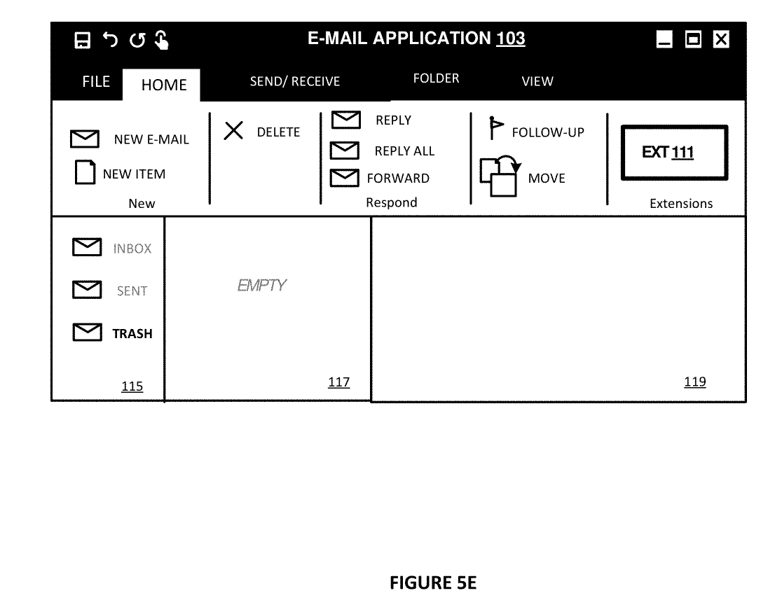

FIGS. 5A-5E illustrate another user interface to e-mail application 103, where the user wishes to save embedded extension 111 for future use. As shown in FIG. 5A, the user may right-click, or otherwise selected embedded extension 111 and a sub-menu appears with the option to save embedded extension 111. In other implementations, e-mail application 103 may prompt the user whether she wishes to save embedded extension 111 when the user closes embedded extension 111. FIG. 5B shows that extension 111 has been added to e-mail application 103; an icon for embedded extension 111 has been added to the “Home” tab under the category “Extensions.” In some implementations, an “Extensions” tab may be added to e-mail application 103. FIG. 5C illustrates that embedded extension 111 is still accessible in e-mail application 103 even after e-mail 109 has been deleted. The “Inbox” folder is currently selected, and e-mail 109 is no longer showing in the “Inbox” folder. FIG. 5D shows that e-mail 109 has been moved to the “Trash” folder, and embedded extension 111 is still accessible in e-mail application 103. FIG. 5E shows that e-mail 109 has been emptied from the “Trash” folder of e-mail application 103, and embedded extension 111 is still accessible from e-mail application 103.

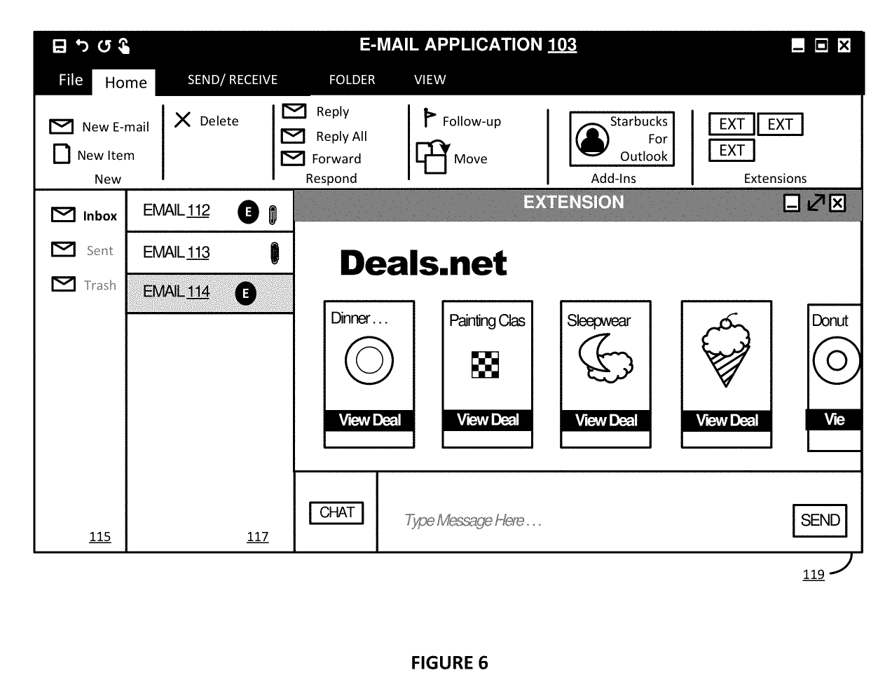

FIG. 6 illustrates an operational scenario for launching embedded extensions in the context of e-mail application 103. In this implementation, e-mail message 114 included an embedded extension is selected. The embedded extensiom is launched when the user clicks on or opens e-mail message 114 containing the embedded extension. The embedded extension is launched in reading pane 119. For example, the extension may comprise a shopping extension containing deals. The deals may be items the user previously searched for. In some implementations, the deals may be tailored or customized for the user based on search criteria, user demographics, etc.

Although not required, the embedded extension may also allow the user to initiate a chat session. In some examples, the chat session may be with a bot. In other examples, the chat session may be with a customer service representative. In other implementations, the embedded extension may be launched in a separate window, but still within the context of e-mail application 103.

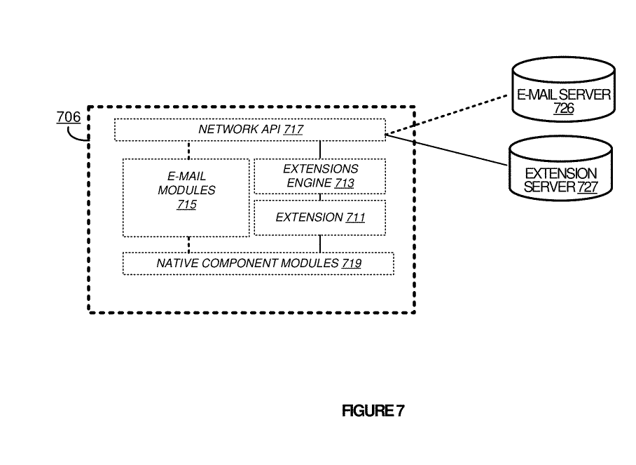

FIG. 7 illustrates a block diagram of an email application 706 in an implementation. Email application 706 is exemplary of an application in which the various features and functionality described herein may be implemented. E-mail application 706 includes one or more software elements represented by extension 711, extension engine 713, e-mail modules 715, network application programming interface(s) (APIs) 717, and native component modules 719. For example, extension 711 may be representative of extension 111 discussed in the proceeding figures. Extension engine 713 is hosted in e-mail application 706 to render extension 711 in user interface system 708 in the context of e-mail application 706. E-mail modules 715 comprise software components to run e-mail application 706, such as sending and receiving e-mail messages, an address book, etc. Native component modules 719 comprise software modules for native controls within e-mail application 706. Network APIs 717 comprise software to communicate with servers, such as e-mail server 726 and extension server 727 over a network, such as the Internet.

Extension 711 can be related to any embedded extension discussed herein, such as a flight check-in extension, seat picker extension, shopping extension, chat extension, messaging extension, bot extension, or other embedded extensions. When extension 711 is launched, for example upon user selection of the e-mail message including extension 711, the extension engine 713 runs extension 711. In some implementations, extension engine communicates with extension server 727 to get updated information to render extension 711 to the user. Extension 711 utilizes native controls of e-mail application 706 by calling native component modules 719. In addition, extension 711 utilizes network API 717 of e-mail application 706 to send and receive data from extension server 727. Similarly, e-mail modules 715 uses network API 717 to access e-mail server 726.

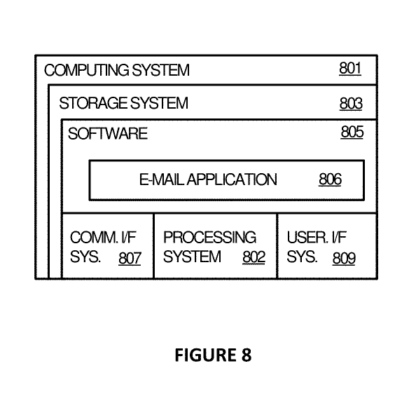

FIG. 8 illustrates computing system 801, which is representative of any system or collection of systems in which the various applications, extensions, services, scenarios, and processes disclosed herein may be implemented. Computing system 801 may be employed to execute an e-mail application, personal information management program, calendar service, communication service, and/or other services, including combinations and variations thereof.

Examples of computing system 801 include, but are not limited to, personal computers, mobile phones, tablet computers, desktop computers, laptop computers, wearable computing devices, server computers, blade servers, rack servers, and any other type of computing system (or collection thereof) suitable for carrying out the launching of embedded extensions in the context of an e-mail application described herein. Such systems may employ one or more virtual machines, containers, or any other type of virtual computing resource in the context of supporting an e-mail application for launching embedded extensions included in e-mail messages.

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 607, and user interface system 809. Processing system 802 is operatively coupled with storage system 803, communication interface system 807, and user interface system 809. In some implementations, user interface system 809 may be omitted. Computing system 801 may include other components omitted for clarity.

Processing system 802 loads and executes software 805 from storage system 803. Software 805 includes email application 806 which is representative of the software applications discussed with respect to the preceding FIGS. 1-7, including e-mail application 103 and email application 706. When executed by processing system 802, software 805 directs processing system 802 to operate as described herein for at least the various processes, operational scenarios, and sequences discussed in the foregoing implementations to launch embedded extensions in the context of an e-mail application. Computing system 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device, but may also be distributed across multiple processing devices or sub-systems that cooperate in executing program instructions. Examples of processing system 802 include general purpose central processing units, extension specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device, but may also be implemented across multiple storage devices or sub-systems co-located or distributed relative to each other. Storage system 803 may comprise additional elements, such as a controller, capable of communicating with processing system 802 or possibly other systems.

Software 805 in general, and e-mail application 806 in particular, may be implemented in program instructions and among other functions may, when executed by processing system 802, direct processing system 802 to operate as described with respect to the various operational scenarios, sequences, and processes illustrated herein. For example, e-mail application 806 may include program instructions for receiving e-mail messages, including e-mail messages with embedded extensions, opening the e-mail messages for viewing, and receiving user input indicating an embedded extension was selected, and in response, launching the embedded extension in the context of e-mail application 806.

In particular, the program instructions may include various components or modules that cooperate or otherwise interact to carry out the various processes and operational scenarios described herein. The various components or modules may be embodied in compiled or interpreted instructions, or in some other variation or combination of instructions. Software 805 may include additional processes, programs, or components, such as operating system software, virtual machine software, or other extension software, in addition to or that include application 806. Software 805 may also comprise firmware or some other form of machine-readable processing instructions executable by processing system 802.

In general, e-mail application 806 may, when loaded into processing system 802 and executed, transform a suitable apparatus, system, or device (of which computing system 801 is representative) overall from a general-purpose computing system into a special-purpose computing system customized to launch extensions embedded in e-mail messages in the context of an e-mail application or client. Indeed, encoding e-mail application 806 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, e-mail application 806 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 809 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 809. In some cases, the input and output devices may be combined in a single device, such as a display capable of displaying images and receiving touch gestures. The aforementioned user input and output devices are well known in the art and need not be discussed at length here.

User interface system 809 may also include associated user interface software executable by processing system 802 in support of the various user input and output devices discussed above. Separately or in conjunction with each other and other hardware and software elements, the user interface software and user interface devices may support a graphical user interface, a natural user interface, or any other type of user interface, in which a user interface to an extension may be presented (e.g. user interface 105).

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. In any of the aforementioned examples in which data, content, or any other type of information is exchanged, the exchange of information may occur in accordance with any of a variety of well-known data transfer protocols.

Certain inventive aspects may be appreciated from the foregoing disclosure, of which the following are various examples.

Example 1. A method of operating an e-mail application to launch an embedded extension in the context of the e-mail application, the method comprising: receiving an e-mail into the inbox of the e-mail application, wherein the e-mail includes an embedded extension, opening the e-mail for viewing, and in response to opening the email, launching the embedded extension in the context of the e-mail application.

Example 2. The method of Example 1 wherein launching the embedded extension in the context of the e-mail application comprises an extension engine associated with the e-mail application launching the embedded extension and the embedded extension executing within the e-mail application.

Example 3. The method of Examples 1-2 further comprising the embedded extension interacting with a third-party service.

Example 4. The method of Examples 1-3 further comprising the e-mail application spawning a guardian application to monitor the third-party service interacting with the embedded extension.

Example 5. The method of Examples 1-4 wherein the e-mail application spawning the guardian application comprises the extension engine associated with the e-mail extension spawning the guardian application and the guardian application executing within the e-mail application.

Example 6. The method of Examples 1-5 wherein the guardian application is not embedded in the e-mail that included the embedded extension.

Example 7. The method of Examples 1-6 further comprising saving the embedded extension to the e-mail application, and deleting the e-mail including the embedded extension from the inbox of the e-mail application, wherein the embedded extension is still accessible in the e-mail application after the e-mail including the embedded extension has been deleted.

Example 8. The method of Examples 1-7 further comprising the embedded extension using native controls included in the e-mail application.

Example 9. The method of Examples 1-8 further comprising closing the e-mail application, wherein closing the e-mail application also closes the embedded extension.

Example 10. A computing apparatus comprising: one or more computer readable storage media; a processing system operatively coupled with the one or more computer readable storage media; and program instructions stored on the one or more computer readable storage media for operating an e-mail application; wherein the program instructions, when executed by the processing system, direct the processing system to at least: receive an e-mail into a inbox of the e-mail application, wherein the e-mail includes an embedded extension, receive user input selecting the e-mail, and in response, open the e-mail including the embedded extension for viewing, and receive user input selecting the embedded extension; and in response, launch the embedded extension in the context of the e-mail application.

Example 11. The computing apparatus of Example 10 wherein the program instructions, when executed by the processing system, further direct the processing system to allow the embedded extension to interact with a third-party service.

Example 12. The computing apparatus of Examples 10-11 wherein the program instructions, when executed by the processing system, further direct the processing system to spawn a guardian application to monitor the third-party service.

Example 13. The computing apparatus of Examples 10-12 wherein the program instructions, when executed by the processing system, further direct the processing system to save the embedded extension to the e-mail application, and delete the e-mail including the embedded extension for the inbox of the e-mail application, wherein the embedded extension is still accessible in the e-mail application after the e-mail including the embedded extension has been deleted.

Example 14. The computing apparatus of Examples 10-13 wherein the program instructions, when executed by the processing system, further direct the processing system to allow the embedded extension to use native controls included in the e-mail application.

Example 15. The computing apparatus of Examples 10-14 wherein the program instructions, when executed by the processing system, further direct the processing system to close the embedded extension when the e-mail application closes.

Example 16. One or more computer readable storage media having program instructions stored thereon to operate an e-mail application, wherein the program instructions, when executed by a processing system, direct the processing system to at least: receive an e-mail into a inbox of the e-mail application, wherein the e-mail includes an embedded extension, receive user input selecting the e-mail, and in response, open the e-mail including the embedded extension for viewing, and receive user input selecting the embedded extension; and in response, launch the embedded extension in the context of the e-mail application.

Example 17. The one or more computer readable storage media of Example 16, wherein the program instructions, when executed by the processing system, further direct the processing system to allow the embedded extension to interact with a third-party service.

Example 18. The one or more computer readable storage media of Examples 16-17, wherein the program instructions, when executed by the processing system, further direct the processing system to spawn a guardian extension to monitor the third-party service.

Example 19. The one or more computer readable storage media of Examples 16-18, wherein the program instructions, when executed by the processing system, further direct the processing system to save the embedded extension to the e-mail application, and delete the e-mail including the embedded extension from the inbox of the e-mail application, wherein the embedded extension is still accessible in the e-mail application after the e-mail including the embedded extension has been deleted.

Example 20. The one or more computer readable storage media of Examples 16-19, wherein the program instructions, when executed by the processing system, further direct the processing system to allow the embedded extension to use native controls included in the e-mail application.

Example 21. The one or more computer readable storage media of Examples 16-20, wherein the program instructions, when executed by the processing system, further direct the processing system to close the embedded extension when the e-mail application closes.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A method of operating an e-mail extension, the method comprising:
receiving an e-mail into an inbox of the e-mail application, wherein the e-mail includes an embedded extension;
opening the e-mail including the embedded extension for viewing; and
in response to opening the email, launching the embedded extension in the context of the e-mail application.

2. The method of claim 1 wherein launching the embedded extension in the context of the e-mail application comprises an extension engine associated with the e-mail application executing the embedded extension within the e-mail application.

3. The method of claim 1 further comprising:
the embedded extension interacting with a third-party service.

4. The method of claim 3 further comprising:
the e-mail application spawning a guardian application to monitor the third-party service.

5. The method of claim 4 wherein the e-mail application spawning the guardian application comprises the extension engine associated with the e-mail application spawning the guardian application and the guardian application executing within the e-mail application.

6. The method of claim 5 wherein the guardian application is not embedded in the e-mail that included the embedded extension.

7. The method of claim 1 further comprising:
saving the embedded extension to the e-mail application; and
deleting the e-mail including the embedded extension from the inbox of the e-mail application, wherein the embedded extension is still accessible in the e-mail application after the e-mail including the embedded extension has been deleted.

8. The method of claim 1 further comprising:
the embedded extension using native controls included in the e-mail application.

9. The method of claim 1 further comprising;
closing the e-mail application, wherein closing the e-mail application also closes the embedded extension.

10. A computing apparatus comprising:
one or more computer readable storage media;
a processing system operatively coupled with the one or more computer readable storage media; and
program instructions stored on the one or more computer readable storage media for operating an e-mail application, that when read and executed by the processing system, direct the processing system to at least:
receive an e-mail into a inbox of the e-mail application, wherein the e-mail includes an embedded extension;
receive user input selecting the e-mail, and in response, open the e-mail including the embedded extension for viewing; and
receive user input selecting the embedded extension, and in response, launch the embedded extension in the context of the e-mail application.

11. The computer apparatus of claim 10 wherein the program instructions further direct the processing system to allow the embedded extension to interact with a third-party service.

12. The computer apparatus of claim 11 wherein the program instructions further direct the processing system to spawn a guardian application to monitor the third-party service.

13. The computer apparatus of claim 10 wherein the program instructions further direct the processing system to
save the embedded extension to the e-mail application; and
delete the e-mail including the embedded extension from the inbox of the e-mail application, wherein the embedded extension is still accessible in the e-mail application after the e-mail including the embedded extension has been deleted.

14. The computer apparatus of claim 10 wherein the program instructions further direct the processing system to allow the embedded extension to use native controls included in the e-mail application.

15. The computer apparatus of claim 10 wherein the program instructions further direct the processing system to close the embedded extension when the e-mail application closes.

16. One or more computer readable storage media having an e-mail application stored thereon comprising program instructions that, when read and executed by a processing system, direct the processing system to at least:
receive an e-mail into an inbox of the e-mail application, wherein the e-mail includes an embedded extension;
receive user input selecting the e-mail, and in response, open the e-mail including the embedded extension for viewing; and
receive user input selecting the embedded extension, and in response, launch the embedded extension in the context of the e-mail application.

17. The computer readable media of claim 16 wherein the program instructions further direct the processing system to allow the embedded extension to interact with a third-party service.

18. The computer readable media of claim 17 wherein the program instructions further direct the processing system to spawn a guardian application to monitor the third-party service.

19. The computer readable media of claim 16 wherein the program instructions further direct the processing system to
save the embedded extension to the e-mail application; and
delete the e-mail including the embedded extension from the inbox of the e-mail application, wherein the embedded extension is still accessible in the e-mail application after the e-mail including the embedded extension has been deleted.

20. The computer readable media of claim 16 wherein the program instructions further direct the processing system to allow the embedded extension to use native controls included in the e-mail application.
